(19) United States
(12) Patent Application Publication
(10) Pub. No.: US 2026/0206686 A1
(43) Pub. Date: Jul. 23, 2026

(54) A SYSTEM AND METHOD FOR BIOMASS CARBON DIOXIDE SEQUESTRATION

(71) Applicant: INTER EARTH PTY LTD, West Perth (AU)

(72) Inventor: Howard CARR

(21) Appl. No.: 19/481,488

(22) PCT Filed: May 6, 2024
(86) PCT No.: PCT/AU2024/050441

§ 371 Date: Nov. 4, 2025

(30) Foreign Application Priority Data
May 5, 2023 (AU) 2023901354

(51) Int. Cl. A01F 25/08; A01F 25/12; A01F 25/14

(52) U.S. Cl. CPC A01F 25/08; A01F 25/12; A01F 25/14

(57) ABSTRACT

A system for biomass carbon dioxide sequestration comprising a harvesting module for harvesting or collecting biomass; a drying module to which biomass assessed to have moisture content greater than a threshold moisture content by weight is directed from the harvesting module for drying said harvested biomass to a dry state where the dried harvested biomass has less than the threshold moisture content by weight; and a storage module for storing harvested biomass assessed to have moisture content by weight less than the threshold moisture content.

### TECHNICAL FIELD

The present invention relates to a system and method for biomass carbon dioxide sequestration.

### BACKGROUND ART

The following discussion of the background art is intended to facilitate an understanding of the present invention only. The discussion is not an acknowledgement or admission that any of the material referred to is or was part of the common general knowledge as at the priority date of the application.

Existing CO₂ sequestration technologies have a number of limitations which result in high capital and/or operating costs, and/or an inability to ensure that CO₂ is effectively captured and removed from the atmosphere or from man-made emissions that would otherwise enter the atmosphere, and securely stored for the long term such that the captured CO₂ does not re-enter the atmosphere as CO₂ or any other “Green House Gas” (“GHG”) particularly methane (CH₄). The definition of key technical terms used in this invention such as: Carbon Dioxide (CO₂), Carbon Sequestration, Carbon Capture, Green House Gas (GHG), among others, is that provided within the articles of the Kyoto Protocol to the United Nations Framework Convention on Climate Change (“Kyoto Protocol”).

Existing CO₂ sequestration technologies can further be divided into two categories, those (a) currently commercially operational; dominantly the underground sequestration of gaseous CO₂ by injection into suitable underground structures and CO₂ sequestration in the living biomass of forests and similar biological systems and (b) technologies still being researched, developed, optimised and field tested that as yet display little-to-no commercial operationality. Of the former, underground CO₂ sequestration technologies involve the following key steps:
1) concentration of CO₂ from the atmosphere or an emission source flue to as close to pure (100% CO₂) as is practically and economically possible,
2) compression of high-concentration CO₂ to the highest density gas as is practically and economically possible,
3) pumping of the high-density gas via interconnected pipelines and drilled wells to allow for the CO₂ gas injection into suitably permeable and porous geological strata,
4) CO₂ gas injection to maximise the volume of gas stored in the strata as far as is practically and economically possible, and
5) on achievement of the strata's gas storage capacity, sealing of the well and the strata with the objective of trapping the CO₂ within the strata in perpetuity.

Underground gaseous CO₂ sequestration systems are characterised by the need to have a suitably porous and permeable geological strata for practical and economic CO₂ injection, sealing and storage in close proximity to the CO₂ collection and/or emission site in order to minimise the construction and operating costs of transmission and delivery pipeline(s). To eliminate the possibility of CO₂ contamination of underground water and/or leakage of CO₂ from its storage site, the targeted underground CO₂ storage strata must also be an acceptable distance below any water-bearing aquifers, which may be an existing, or future, source of potable, agricultural or industrial water.

The majority of the operating costs of underground CO₂ storage is in the concentration of CO₂ at or adjacent to the emission and/or collection site and the pumping of the compressed CO₂ into the underground strata. If the CO₂ emission gas stream has an initially high CO₂ concentration and the distance to the storage site is short, and the strata is geologically and geotechnically acceptable and the CO₂ gas does not leak from the storage strata, underground CO₂ sequestration can be an effective CO₂ sequestration technology. If any of the above conditions are not met, underground CO₂ sequestration by this means will be cost ineffective and/or not achieve the primary objective of sequestering CO₂ in perpetuity.

Biological CO₂ sequestration systems, in contrast, primarily rely on photosynthesis for the collection and concentration of atmospheric CO₂ and are characterised by the need to have suitable tracts of the land (or in some cases suitable tracts of sea or seabed) to grow plant biomass and once grown to maturity sustain that biomass such that the total quantum of grown biomass and absorbed CO₂ remains constant into the future. To eliminate the possibility of large-scale return of CO₂ to the atmosphere requires significant and sustained management to mitigate risks associated with (a) natural disturbances such as wildfires, pests, disease and drought and (b) anthropogenic disturbances such as harvest and deforestation for change of land use.

The majority of the costs associated with biological CO₂ sequestration systems arise from the extensive areas needed and the fact that those areas may be in competition with other uses such as food or bio-fuel production or an existing conservation purpose. There are also significant costs in the ongoing management of biological CO₂ Sequestration systems during their growth phase and once they have reached maturity even long after net removal of CO₂ from the atmosphere has ceased. If either effective long term management arrangements are not in place or the natural and anthropogenic risks mentioned above cannot be effectively addressed, biological CO₂ sequestration systems will not meet the primary objective of sequestering CO₂ in perpetuity.

There are further CO₂ sequestration technologies, often used in an industrial context, including:
(a) Absorption systems involving variously amine, carbonate, ammonia, hydroxide and limestone based reagents;
(b) Adsorption systems involving metal organics and zeolite based reagents;
(c) Membrane systems involving microporous and fibre-based components; and
(d) Other technologies involving mineralisation and cold separation systems.

These CO₂ sequestration technologies are not typically suitable for use in combination with sequestration of CO₂ via plant based sequestration.

It is against this background that the present invention has been developed.

### SUMMARY OF INVENTION

The present invention provides, in one aspect, a system for biomass carbon dioxide sequestration comprising:
(a) a harvesting module for harvesting or collecting biomass;
(b) a drying module to which biomass assessed to have moisture content greater than a threshold moisture content by weight is directed from the harvesting module for drying said harvested biomass to a dry state where the dried harvested biomass has less than the threshold moisture content by weight; and
(c) a storage module for storing harvested biomass assessed to have moisture content by weight less than the threshold moisture content. The object of storage is to maintain the stored biomass in a substantially dry and preserved state with minimal to no microbial activity occurring within the storage module.

Where harvested biomass from the harvesting module is assessed to have less than the threshold moisture content by weight, it may be directed to the storage module without further drying in the drying module. However, this is not intended to preclude direction of all harvested biomass, even of harvested biomass having less than the threshold moisture content, to the drying module either to make operation of the system more practical or efficient.

The threshold moisture content is advantageously an equilibrium moisture content (EMC) as understood in the art of wood processing and use. With moisture content below the EMC, microbial activity substantially reduces or stops altogether due to the lack of availability of moisture necessary to sustain microbial viability. This allows preservation of the stored biomass. In this specification, ‘equilibrium moisture content’ or EMC of biomass is here defined as the moisture content in the biomass which is in thermodynamic equilibrium with the moisture in the surrounding atmosphere at a given relative humidity, temperature and pressure.

EMC is therefore a function of relative humidity, temperature and pressure—possibly amongst other factors—and will vary on climatic conditions at the location of the storage module. However, EMC would typically be 30 wt % moisture or below, preferably 20 to 25 wt % moisture or below. For example, an EMC in the range 5 to 15 wt % moisture content would be regarded as a minor proportion of moisture and acceptable as a threshold moisture content.

Advantageously, the biomass includes above ground biomass (AGB) of woody plants and trees compositionally dominated by lignin, hemicellulose, and cellulose, which may be termed “hard celled” AGB, in contrast to “soft celled” AGB typical of commonly cultivated grasses. However, the biomass may also include below ground woody biomass being roots, stumps and lignotubers and soft celled grasses.

The system may include a plurality of each of the harvesting module, the drying module and the storage module, each of which may have a determined capacity in weight and/or volume. It will be appreciated that the volume of biomass will typically reduce during drying and storage; required capacity of the storage module may be determined based on such volume reduction.

The harvested biomass is desirably processed in the harvesting module through chunking in a chunker to control particle size, desirably to a particle size that-while sufficiently large to aid preservation-allows the biomass to flow. A preferred chunker is described in the Applicant's International Application No. PCT/AU2023/051367, the contents of which are hereby incorporated herein by reference.

The system conveniently includes a transport module which allows transport of biomass between harvesting and drying modules and between drying modules and storage modules. The transport module may comprise at least one vehicle which may be configured in either a harvesting mode or a mobile storage mode, as required. In one embodiment, a vehicle configured for harvesting mode may be as described in the Applicant's co-pending International Application No. PCT/AU2023/051367, incorporated herein by reference.

The drying module allows drying of the biomass. Solar drying is preferred as a cost effective drying method. Solar drying allows for assistance of drying of biomass by wind flow and dry air. However, other forms of biomass drying are not precluded. The drying module may include one or a plurality of drying stages.

The storage module is desirably water proof and insect proof. In particular, the storage module should be termite proof. Termite proofing desirably avoids use of chemical insecticides, but may include the use of chemical insecticides in the event that termites breach the termite barrier. In one embodiment, the storage module may be located on ground having an termite barrier separating the storage module from the ground. The termite barrier may comprise a contiguous saline soil layer, conveniently comprising or consisting of sodium chloride in excess of 1% NaCl by weight. Such a saline layer is toxic to termites. The storage module is also desirably both dark (i. e with a substantial absence of light) and fire proof.

The storage module desirably further comprises a ventilation system for circulation of air through the stored dry biomass to prevent decomposition. The ventilation system may comprise a system of perforated pipes extending through the stored biomass. Pipes may open outside the storage module for collection of air for ventilation. The ventilation system preferably comprises at least one ventilation stack extending beyond the stored biomass. The ventilation stack may be modular, allowing a length of the ventilation stack to be modified dependent on quantity of stored biomass.

The ventilation stack preferably comprises an extractor fan for creating a draft through the stored biomass. Desirably, the extractor fan is powered by renewable energy such as wind or solar power.

The storage module also desirably further comprises a monitoring system for a parameter which may be selected from the group consisting of biomass moisture content, biomass temperature, relative humidity of ventilation air and gas composition of ventilation air. Gas composition monitoring may include monitoring of CO₂, CO and/or CH₄ composition by selected sensor(s). Monitoring allows verification of the effectiveness of the biomass carbon dioxide sequestration system and method as described herein. Each sensor desirably has its spatial position (e.g in x-y-z frame or polar coordinates) within the storage module recorded. The sensed data, together with position recordal, conveniently allows defects in the storage module allowing undesirable moisture permeation to be located and addressed.

The storage module has a structure preventing migration of moisture into the stored biomass as such moisture ingress may promote biomass decomposition. Such a structure may comprise a base layer preventing upward migration of moisture into said stored biomass and a roof structure preventing downward and/or lateral migration of moisture into the stored biomass. The base layer and roof structure may be formed from a material selected from the group consisting of clay, soil, polymer sheet and a combination of these materials to form a water impermeable barrier. Such a barrier also excludes entry of other agents that may cause deterioration of the stored biomass and is further desirably fire proof. The roof structure may also be configured, for example by selection of material and/or material thickness, to reduce or avoid light ingress into biomass stored in the storage module.

The storage module is desirably surrounded by a floodwater barrier, where required, for preventing flood damage or water ingress to the stored biomass.

In another aspect, the present invention provides a method for biomass carbon dioxide sequestration comprising:
(a) harvesting or collecting biomass;
(b) drying said harvested biomass where harvested biomass is assessed to have moisture content greater than a threshold moisture content by weight so that the dried harvested biomass has less than the threshold moisture content by weight; and
(c) storing said harvested biomass assessed to have moisture content less than the threshold moisture content. Again the object is to store the harvested biomass in a substantially dry and preserved state.

The system and method for biomass carbon dioxide sequestration has a number of potential advantages including the possibility for storing biomass in marginal land in a system of simple and relatively inexpensive construction in comparison to the value of carbon credits that may be derived utilising the system and method.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a schematic block diagram of a system for biomass carbon dioxide sequestration according to one embodiment of the present invention.

FIG. 2 is a schematic plan view of a biomass plantation showing relative positioning and surface areas of drying module and storage module in relation to the biomass plantation according to one embodiment of the present invention.

FIG. 3 is a schematic side view of a biomass recovery vehicle for transferring biomass from the drying module to the storage module.

FIG. 4 is a schematic plan view of the biomass recovery vehicle of FIG. 3.

FIG. 5 is a schematic plan view of the site of a biomass storage module showing a biomass storage pad for a biomass storage facility and associated earthworks.

FIG. 6 is a schematic end view of the site of the biomass storage pad as shown in FIG. 5.

FIG. 7 is a partial end view of the biomass storage pad as shown in FIGS. 5 and 6 and showing a biomass stack including its ventilation system.

FIG. 8 is a partial side view along the short axis of biomass storage pad of the same construction as shown in FIGS. 5 to 7 and showing the stacking arrangement.

FIG. 9 is a schematic side view of a stacking system for a biomass stack such as that shown in FIG. 7.

### DESCRIPTION OF PREFERRED EMBODIMENTS

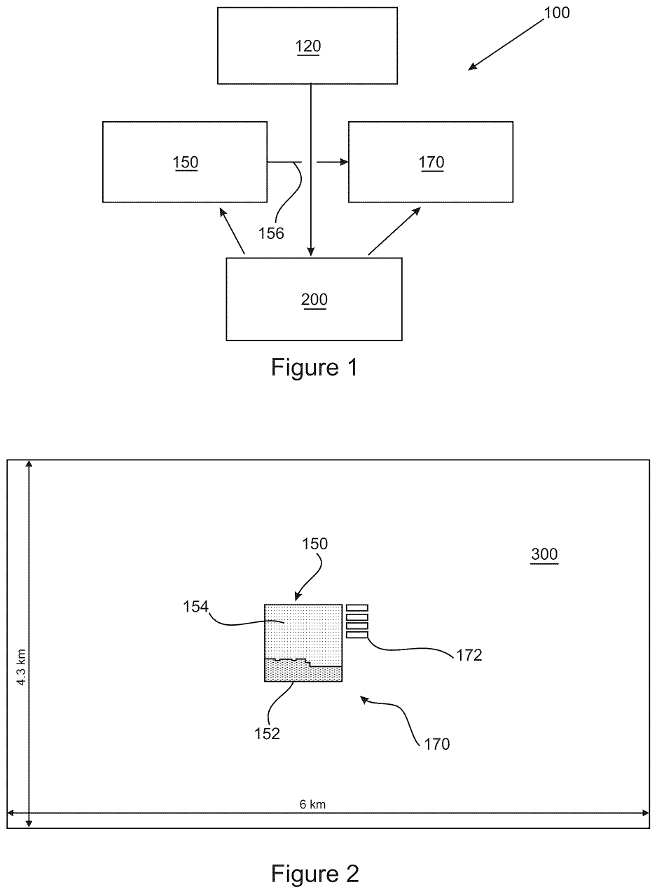

Referring now to FIG. 1, there are shown the component modules of a system 100 for biomass carbon dioxide sequestration. In preferred embodiments, the biomass includes above ground biomass (AGB) of woody plants and trees compositionally dominated by lignin, hemicellulose, and cellulose, which may be termed “hard celled” AGB, in contrast to “soft celled” AGB typical of commonly cultivated grasses. However, the biomass may also include soft celled grasses. Further description of candidate woody plants as a source of AGB is provided below.

System 100 includes a harvesting module 120, a drying module 150 and a storage module 170.

Harvesting module 120 allows for harvesting or collecting biomass assessed to have a substantial proportion of moisture. A ‘substantial proportion of moisture’, in the embodiments, is a moisture content in excess of a threshold, pertinently in preferred embodiments the equilibrium moisture content (EMC) as understood in the art of wood processing and use. A “minor proportion of moisture” in the embodiments may be used to describe a moisture content below EMC. EMC of biomass may be defined as the moisture content which is in thermodynamic equilibrium with the moisture in the surrounding atmosphere at a given relative humidity, temperature and pressure.

Drying module 150 allows drying of the harvested biomass, where necessitated by its moisture content being assessed as above EMC, to a dry state in which said biomass has a minor proportion of moisture, i.e. a moisture content below a threshold level. A ‘minor proportion of moisture’, in the preferred embodiments, is a moisture content of less than about 20%, for example between 10% and 15% by weight. Without wishing to be bound by theory, this moisture content, or the equivalent water activity, is below EMC eliminating any available free moisture required for microbial metabolism and growth and consequential biomass decomposition. Thus the dried biomass is able to be stored in an inert state, permanently sequestering photosynthetically captured CO₂ out of the atmosphere.

To achieve such required low moisture content, or water activity, drying module 150 comprises a biomass drying facility 152. In the event of harvesting or collecting biomass assessed to already be dried to below EMC, this step can be skipped and dried biomass can be transported directly to the storage module 170.

Biomass moisture content may be assessed in a number of ways. A simple methodology based on weight involves first weighing the biomass (termed the green weight), dehydrating the biomass in a heater or oven at a selected temperature for selected duration to enable water to evaporate and then weighing the biomass again (this being the ‘dry’ weight). The difference between the two weight measurements is the assessed moisture content. In one embodiment, the selected temperature may be 50° C. and the selected duration 5 hours. Other methods of moisture assessment, for example employing moisture meters or sensors, could be used.

Storage module 170 allows for storage of harvested biomass in a substantially preserved and dry state. Storage module 170 comprises a biomass storage facility 172.

System 100 also includes a transport module 200 which allows transport of biomass between harvesting module 120 and drying module 150 and between drying module 150 and storage module 170. The transport module 200 here comprises a range of vehicles which may be configured in a harvesting mode and stacking mode as described below. In one embodiment, a vehicle 1100 configured for harvesting mode may be as described in the Applicant's International Application No. PCT/AU2023/051367, incorporated herein by reference. Vehicle 1100 has a chunker to cut biomass into a selected particle size suitable for direction to the drying module 150.

### Biomass Drying Facility (BDF)

Chunked fresh AGB biomass, AGB biomass being as above described and described in further detail below, is deposited from a biomass transportation vehicle onto biomass drying facility (BDF) 152 which comprises a drying pad 154 and a dedicated biomass recovery machine 210.

BDF 152 is located adjacent biomass storage facility (BSF) 172. In this embodiment, as shown in FIG. 2, both BDF 152 and BSF 172 are located close to the geographic centre of a biomass production plantation 300 from which the AGB biomass is sourced to minimise the biomass transportation distance.

The BDF 152 and BSF 172 may, in embodiments, be located within an area of sufficient surface area to construct a number of similar purpose-built BSF facilities to accommodate future biomass production. The BDF 152 can be used for repeated harvest and storage events occurring, for example, approximately every two years. It will be understood that, in other embodiments, harvest events can occur at different frequency.

Advantageously, the BDF 152 and BSF 172 are located on the margin of natural or human-induced salt flats or salt lakes, land with no vegetation (other than the biomass production plantation 300) and usually having a variable thickness crust of salt in a climatic zone where evaporation greatly exceeds precipitation. Similarly degraded or low production land including salinated, hardpanned or wind-blow or rocky land or irregularly shaped cultivated land that is difficult to economically cultivate, would also be suitable for the BDF 152 and BSF 172. While other embodiments may enable other forms of land to be used, land as above described is plentiful across the Australian continent.

The BDF drying pad 154 is a flat area of land, conveniently as above described, with little to no preparation required. Drying pad 154 has high direct exposure to sunlight and heat to enable biomass drying by solar or sun drying.

Chunked fresh biomass may have a moisture content between 35% and 55% by weight, typically around 45% by weight as assessed by a method such as that described above. The chunked fresh biomass is dumped from a mobile transport vehicle conveniently a truck-based tipper, or a similar mobile bulk handling cart capable of transporting an economically viable weight of low density biomass, onto the BDF drying pad 154 in rows. The rows may in such case be, for example, around 3 m wide and 2.5 m high. A front end loader with a large biomass push rake may be used to level the rows into as flat, even and continuous layer as is practical. The layer of chunked fresh biomass has thickness to optimise drying time with available surface area and available labour for operating the mobile transport vehicle and front end loader.

The layer of chunked biomass is allowed to dry undisturbed on the BDF drying pad 154 until it is assessed to have a moisture content of less than EMC, preferably below about 20% by weight and preferably between 5 and 15% by weight, for example 10% by weight.

During drying, the biomass is sampled and analysed for moisture content, moisture content being assessed for example by the method described above. When a determined minor proportion of moisture is present, the biomass is recovered from the BDF drying pad 154 for transport and delivery to the BSF 172.

### Recovery of Dried Biomass

Dried biomass 156 is recovered from the BDF drying pad 154 and loaded into a biomass transport vehicle, conveniently a truck based tipper or a similar mobile bulk handling cart capable of transporting an economically viable weight of low density biomass, with a front end loader equipped with a low tare weight, large capacity, biomass bucket. Suitable buckets are known in the art of front end loaders and truck based tippers. The operational capacity of the front end loader is matched to that of the biomass transport machine(s) and the biomass stacker to ensure an optimal biomass material flow rate.

Alternatively, the dried biomass may be recovered from the BDF drying pad 154 and loaded into a biomass transport vehicle, conveniently a truck-based tipper, tipper or a similar mobile bulk handling cart capable of transporting an economically viable weight of low density biomass, with a mobile biomass recovery machine (BRM) 320, that continuously picks up the dried biomass, temporarily stores it on board and then delivers it to the biomass transport vehicle.

The BRM 320 has the following functionality: biomass pick up, biomass concentration, temporary on-board storage and biomass elevation to allow for the continuous recovery and delivery of dried biomass from the layer of dried biomass spread on BDF drying pad 154 into the biomass transport vehicle for delivery to the biomass storage facility (BSF) 172.

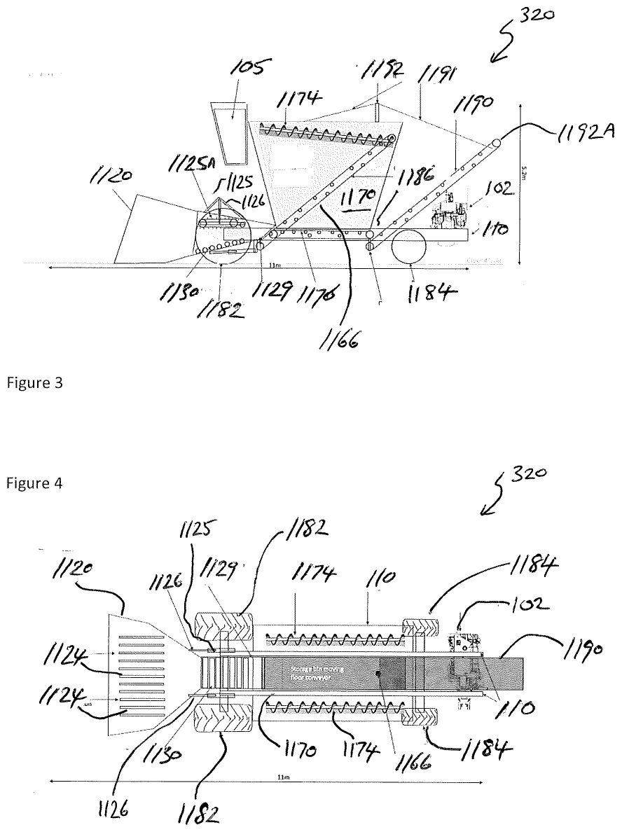

FIGS. 3 and 4 show one embodiment of BRM 320 (exemplary length 11 m and maximum height 5.2 m) and it will be understood that other configurations could be adopted. BRM 320, as described below, has common features with the harvester machine of the Applicant's International Application No. PCT/AU2023/051367, the contents of which are incorporated herein by reference. Use of the same reference numerals reflect the similarity in configuration.

BRM 320 has a chassis 110 having a pair of front driving wheels 1182 and a pair of rear steering wheels 1184. Rear steering wheels are driven by diesel power unit 102 though it will be understood that different power plant, for example electric motors, can be used if desired and subject to the availability of electric power. Diesel power unit 102 is, in this embodiment, mounted at the rear end of the chassis 110.

Chassis 110 also has a front end comprising a pick up bucket 1120 for collecting biomass. The pick up bucket 1120 is conveniently of steel though other equally environmentally robust metallic or polymeric materials may be used if desired. As shown in FIG. 4, the floor of pickup bucket 1120 is provided with a plurality of parallel slots 1124 which allows separation of soil having a generally smaller particle size than the chunked biomass. Hydraulic rams 1126 allow movement of the pick up bucket 1120, in particular in upward and downward directions.

Aft of pickup bucket 1120 is located transfer elevator 1125 having a housing including an upper conveyor 1125A and a lower conveyor 1130. Elevator 1125 allows rearward and upward transfer of biomass at a controlled rate from pick up bucket 1120 towards biomass storage hopper 1170. Upper conveyor 1125A has rakes to assist in forcing biomass rearward. Lower conveyor 1130 is conveniently a powered continuous loop chain mail belt in this embodiment. It will be understood that other configurations for the transfer elevator 1125 are possible. Its function is transport of biomass towards, or to, storage hopper 1170.

The biomass storage hopper 1170 is mounted approximately midway along the length of chassis 110. Its capacity in this embodiment is about 6 tonnes. Hopper 1170, conveniently made of steel though other suitable storage hopper materials may be used as known in the hopper manufacture art, is provided at its top with two augers 1174 disposed in parallel to redistribute chunked biomass transferred or fed from elevator 1125 to the hopper elevator 1166. At the bottom of hopper elevator 1166 is located a rear hinge point 1129 for the elevator housing 1125. The rear hinge point 1129 accommodates movement of BRM 320 over ground without exposing the elevator housing 1125 and other components to the risk of damage that would be present in its absence.

Biomass storage hopper 1170 has as its floor a conveyor 1176 which, in operation, transfers biomass rearwardly towards an outlet chute 1186 where biomass is discharged.

Just forward of biomass storage hopper 1170 is the operator cabin 105 from which an operator can operate BRM 320 using a suitable control system.

Biomass is discharged from outlet chute 1186 to the bottom of outload conveyor elevator 1190. The upper end 1192A of outload conveyor elevator 1190 is supported by guywires 1191 connected to a traverse point 1192 provided at the top of storage hopper 1170. Outload conveyor elevator 1190 conveniently feeds a biomass transport machine 330, conveniently a truck-based tipper, for transport of biomass to the BSF 172. The outload conveyor elevator 1190 discharges biomass at height suitable for the biomass transport machine 330.

A plurality of BRMs 320 and/or biomass transport vehicles may be deployed dependent on the capacity of the system 100.

The BRM 320 allows optimal integration, in particular the cycle time, of the operation of biomass transport machine and the biomass stacker with the biomass recovery system for the efficient, continuous and cost-effective recovery, delivery and stacking of the dried biomass 156.

### Biomass Storage Facility

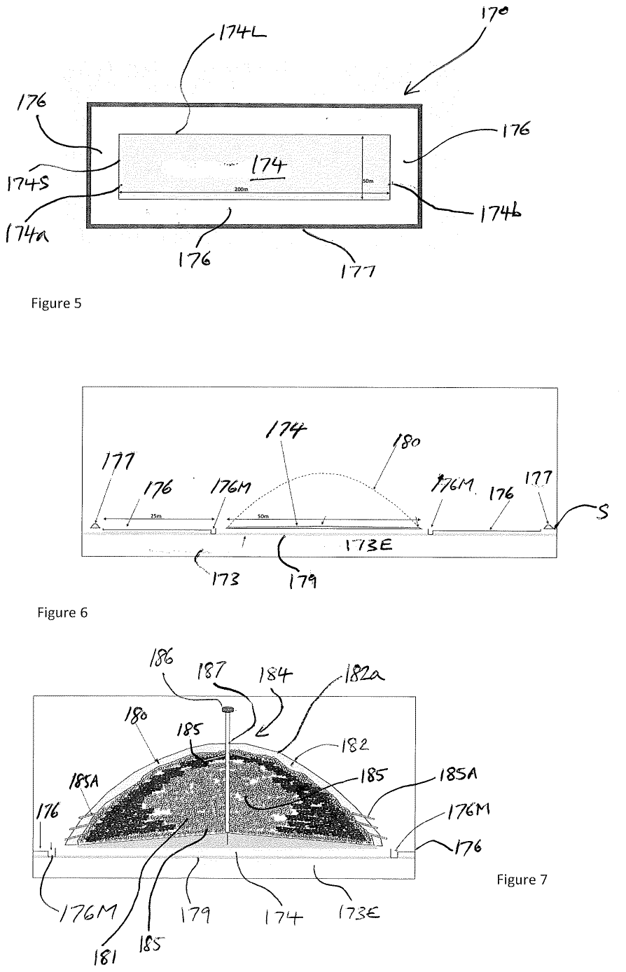

In a preferred embodiment, as indicated in FIGS. 5 and 6, biomass storage facility 172 and a pad 174 accommodating it is located on the margin of natural or human-induced salt flats or salt lakes 173 in one example characterised by a thick, high clay content salinated soil 173E. The soil layer may be >2m thick with >30% clay with electrical conductivity >16 ds/s and TDS >10000 ppm (mostly as NaCl). The clay content of the soil is sufficient to ensure that, upon optimal compaction, the soil has hydraulic conductivity less than 10-9 ms⁻¹. There is an abundance of such land in Western Australia and other parts of the globe.

Often, such soils have a saline (e.g. 10000 ppm TDS typically as NaCl) to hyper-saline (e.g. 250000 ppm TDS typically as NaCl) ground water table 179 which may, for example, be located 500 mm to 1500 mm below natural ground level and usually around 700 mm below natural ground level. A halite dominated salt crust is often present on the soil surface as well. The halite crust may, for example, have a thickness of 1-20mm.

Advantage is obtained where the salinated soil at the site contains greater than 1% NaCl, particularly where there is a continuous soil horizon of determined thickness, for example no less than 50 mm thick and conveniently about 1 m thick.

Although not as advantageous, if naturally salinated soils are not available, any relatively flat, high clay content soil site may be used to construct the BSF 172. In such cases, a salt (most conveniently NaCl for reasons that will become apparent below) may be added to and incorporated into a top layer of the soil where the BSF 172 is to be located. In the event that high clay content soil is not readily available, any soil can be utilised, with appropriate attention to compaction to mitigate moisture ingress and soil erosion.

The BSF storage pad 174 may be constructed with earthmoving machinery, typically involving a bulldozer, motor grader or front end loader. The soil is excavated or graded, to form a spoon drain or shallow trench 176 adjacent to, and surrounding, the BSF storage pad 174. The soil from the spoon drain or shallow trench is pushed up to form the BSF storage pad 174 (as shown in FIGS. 5 and 6). In an exemplary embodiment, the BSF storage pad 174 is between 200 mm and 1500 mm above, for example about 500 mm above, the natural ground level at the centre.

Biomass storage pad 174 has a low angle (1:100) slope down from the centre to the edge. The storage pad 174 may be any desired size though for benefit, in terms of economies of scale, exemplary dimensions would be at least 10 m wide and preferably about 50 m wide, with length at least 50 m and preferably about 200 m.

The excavated spoon drain or shallow trench 176 around the BSF storage pad 174 forms a shallow drain or sump, lower than the natural ground level enveloping the storage pad, being salt lake or salt flat or any other low productivity or suitable soil 173. The trench 176 thus provides an evaporation sump for rainfall that falls on the BSF storage pad 174. Surface water collects in the trench 176 and is evaporated.

On the outer edge of trench or drain 176, a bund 177 is constructed encircling the biomass storage facility 172. The bund 177 does not have to be circular in shape and could, for example, be rectangular as shown. Soil to construct bund 177 is conveniently sourced from a shallow trench adjacent to the bund 177. The soil is pushed up with earthmoving machinery, conveniently a bulldozer or front end loader.

The bund 177 should have height greater than anticipated floodwater level over a substantial timeframe. For example, the height is preferably higher than the level for a rainfall and flooding event that the site would experience in at least 1 in 100 years, more preferably a 1 in 1000 year rainfall and flooding event to provide great security of biomass carbon dioxide sequestration. For the site shown in FIGS. 5 and 6, bund 177 has height greater than 500 mm, more preferably greater than 1000 mm and, for example, 1500 mm. It will be appreciated that such height varies with location and flood risk.

Once the natural or created salinated soil is pushed into place to form the shape of the BSF storage pad 174, the surface is scraped or bladed with an earthmoving machine, ideally a motor grader, to be as even as practical with a slope (for example of about 1 in 100), down away from the centre line, C, of the long axis of the BSF storage pad 174.

For the site shown in FIGS. 5 and 6, the salinated soil 173E of the salt lake 173 is naturally moist, typically having a moisture level conducive to compaction of soil 173E. Such moisture level may be in the range 12 to 18 wt % moisture, for example about 14 wt % moisture as assessed, for example, by a soil moisture meter. If the salinated soil 173E moisture is below the desired range, water may be sprayed on the surface, prior to compaction, to achieve that level in the uppermost soil horizon of the BSF storage pad 154. The uppermost soil horizon layer is preferably at least 50 mm thick, more preferably about 100 mm thick.

Where water is sprayed over the soil surface, care is to be taken not to over water the soil and, desirably, no water run-off should occur. Once the target soil moisture is achieved, the BSF storage pad 154 is compacted with a mobile compactor designed to efficiently compact the surface and construct a surface hard pan with very low hydraulic conductivity as described above.

Where a soil is not salinated, the soil is pushed up and scraped or bladed as flat as practical, in the same manner and in the same dimensions as described for the salinated soil. A similar encircling bund 177 is provided to mitigate flooding from at least a 1 in 100 year rainfall or flood event for the site.

Once the non salinated pad is even and of the design slope, and prior to compaction, it is cultivated to a selected depth with an agricultural tillage implement. Selected depth is preferably at least 35 mm, more preferably about 75 mm. The agricultural tillage implement conveniently comprises tines, preferably spaced up to about 150 mm apart. In embodiments, the agricultural tillage implement forms harrows in a configuration typical for cereal crop seed preparation. NaCl is then evenly applied to the harrows in the surface at an application rate desirably greater than 10 kg/m², for example about 13 kg/m². The prepared BSF storage pad 174 surface is then again cultivated with the same tillage equipment to incorporate the NaCl into the prepared surface horizon of nature as above described. The surface of the BSF storage pad 174 is then scraped or bladed with the motor grader or other earthmoving machinery to be as flat and even as practical.

The volume of material above the natural ground surface, S, that comprises the BSF storage pad 174 acts to reduce upward moisture migration towards the biomass stack 180. The surface hardpan of the BSF storage pad 174 acts as an additional dampcourse to further inhibit upward migration of moisture into the biomass stack 180. Such moisture creates a risk of biomass decomposition and loss of carbon dioxide sequestration. Further, biomass stack 180 is provided with a roof structure 182, for example of plastic membrane or compacted clay soil cover, as described below, acts to eliminate downward and lateral migration of moisture from rainfall events into the biomass stack 180. In this way, the biomass within the biomass stack 180 is kept dry and dark, both factors that are important to effective biomass carbon dioxide sequestration.

The greater than 1% NaCl content of the salinated soil is also selected to create a hostile, toxic environment for termites which would digest the biomass, ultimately release carbon dioxide or other greenhouse gases, and defeat the purpose of sequestration. Termites cannot survive in the saline conditions described. The saline environment of the salt lake or salt flat and the saline soil horizon of the storage pad whether natural or created, 174 act as biological termite barriers. The salt remains in place in the salinated soil 173E and is not removed being protected by the biomass stack 180 covering the storage pad 154. The dry nature of the biomass stack 180 is a further deterrent to termites which prefer wood with moisture above EMC.

In some embodiments, at the completion of the biomass stack 180 and the cessation of earthmoving and heavy machinery movements, termite traps comprised of untreated termite-friendly woody biomass baits, conveniently inside an accessible container around 150 mm in diameter, are buried with the top of the trap just below surface level and each trap being around 2 m outside the edge of the stack and spaced apart, for example 2 m apart, so that the traps form a continuous chain of traps enveloping the biomass stack 180. Termite traps are regularly monitored for termite activity adjacent to the stack 180. In the event of termite activity being detected, conventional chemical termiticides are applied to the stack's ventilation system 184 inlet pipes in accordance with product handling and specifications for use. Termite traps are re-baited with woody biomass and regular monitoring resumes for subsequent termite treatment as necessary. Other termite mitigation strategies may be employed in other embodiments, the foregoing being merely illustrative of one strategy.

At this point, the BSF storage pad 174 is ready for installation of a ventilation system 184 prior to the deposition, stacking and covering of the dried biomass.

Ventilation system 184 is provided to ensure air ventilation of the biomass stack 180 by an at least adequate throughflow of air from the outside through the biomass stack 180. Given that the climate for the biomass carbon dioxide sequestration system 100 is characterised by annual pan evaporation greatly exceeding annual rainfall, ambient air is substantially of low moisture content such that the overall effect of air flow from ventilation system 184 is drying such that the biomass stack 180 is kept dry, a key element assisting in preservation of the biomass (and effective carbon dioxide sequestration) within stack 180.

In an embodiment, for example as shown in FIG. 7, the ventilation system 184 comprises a network of perforated ventilation pipes 185 supplied with air by a fan 186 such that air is distributed throughout the pipes, perforations and throughout the biomass stack 180.

In exemplary embodiments, a plurality of spaced ventilation pipes 185 are laid on the surface of the storage pad 154, for example with their long axis directed towards and at right angles to the edge 154a of the storage pad 174. The ventilation pipes 185A extend a distance beyond the edge of the storage pad 174. Once stacked biomass is covered by roof structure 182, the ventilation pipes 185A facilitate the flow of air from outside to inside a storage chamber 181 of biomass stack 180.

Biomass stack 180 further include one or more ventilation stacks 187, one of which is centrally located and shown in FIG. 7. The ventilation stack 187 desirably extends vertically and is, like the ventilation pipes 185, desirably perforated along its length. If a plurality of ventilation stacks 187 are provided, they are spaced apart, for example 5 m, 10 m, 15 m or 20 m apart. Each ventilation stack 187 must extend beyond the uppermost height of the biomass stack 180 a distance not less than 1.0 m, optionally 1.5 m, optionally 2 m and, for example, around 2.5 m. As air flowing through ventilation stack(s) 187 is not expected to contain more than very low levels of greenhouse gases, such as methane and carbon dioxide, no scrubber for removing such greenhouse gases is required.

If required, in particular whilst the biomass stack 180 is being stacked with biomass, ventilation stack(s) 187 may be held in place in a vertical position by support means selected from the group consisting of guy wires, ropes or fixtures fixing the ventilation stack(s) 187 to the storage pad 154. Such support means may be removed once the biomass stack 180 is sufficient to hold ventilation stack(s) 187 in place.

Alternatively, or additionally, ventilation stack 187 may be conveniently modular and may comprise a plurality of sections, conveniently of defined length though it is not necessary for each ventilation section to have the same length. Such sections may be connected together to form the or each ventilation stack 187.

Each of the vertical ventilation shaft(s) 187 is equipped on the top end with an extractor fan 186 which is desirably operated with renewable energy, for example the extractor fan 186 is wind powered. The extractor fan 186 creates an airflow through ventilation pipes 185A and an upward draft inside each ventilation shaft 187. As shown in FIG. 7, ventilation shaft 187 has a plurality of branching smaller diameter pipes 185 connected to perforations of the ventilation shaft 187. The arrangement of pipes 185, 185A, ventilation shaft 187 and extractor fan 186 allows air to be drawn in from throughout the height of the biomass stack 180 into the pipes 185 and up the ventilation shaft 187 to be expelled at the top of the ventilation shaft 187.

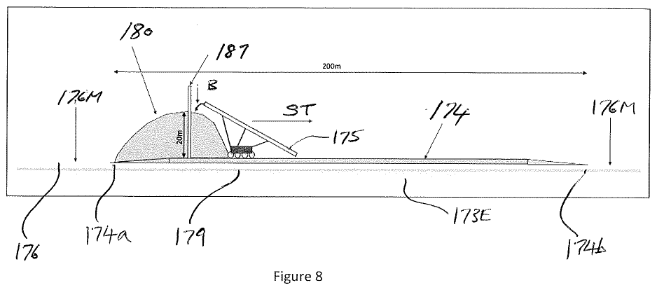

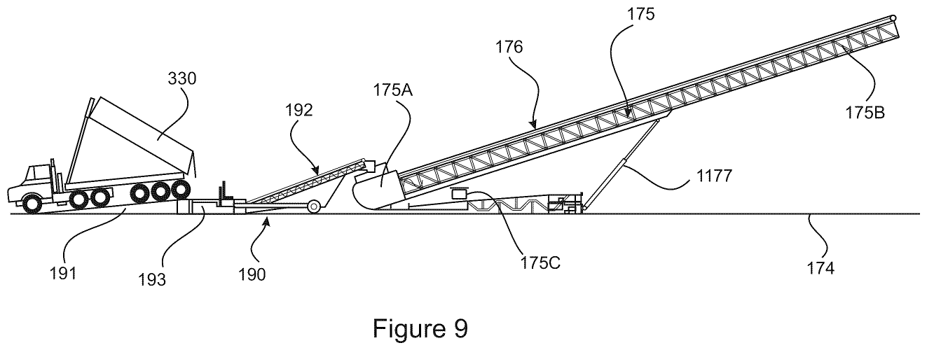

As indicated in FIGS. 8 and 9, dried biomass 156 recovered from the BDF drying pad 154, or if the dried biomass is below EMC at the point of harvest transported direct from the field, is delivered to the BSF storage pad 174 by biomass transport machine, i.e. truck tipper or similar bulk handling mobile cart, 330, as described above.

Upon arrival at the BSF storage pad 174, all dried biomass loads (or loads having harvested biomass with moisture content assessed already below EMC without drying) are weighed to determine the biomass payload of each load and cumulatively the total weight of dried biomass that is deposited, stacked and stored on the storage pad 174. Weighing can be achieved by any appropriate payload weighing technology including electronic load cells mounted within the biomass transport vehicle 330, or portable electronic weighpads or a portable or fixed weighbridge. All individual payload weights are recorded and summed together to determine the total weight of biomass stored on the Storage Pad.

Biomass stacker 175 then allows stacking of the biomass in a stack 180 of selected height, here 20 m, though this can be selected depending on costs of equipment required to perform the stacking operation and biomass throughput to BSF 172.

In a stacking operation, dried biomass 156 is conveniently unloaded from the truck tipper or similar bulk handling mobile cart 330 into a biomass unloader unit 190 located adjacent to a mobile biomass stacker 175. The biomass unloader unit 190 receives the dried biomass and loads the dried biomass into the hopper 175A of the biomass stacker 175 as shown in FIGS. 8 and 9. Biomass stacker 175, in the embodiment shown, includes a frame 175B supporting a belt conveyor 176, a hydraulic ram system 1177 to raise frame 175B to a height required for stacking. The biomass stacker is driven by an operator located in operator cabin 175C.

Biomass unloader unit 190 may be provided in a range of configurations. In some embodiments, it may not be required. In the embodiments described here, mobile biomass unloader unit 190 allows biomass to be tipped from truck tipper or similar bulk handling mobile cart 330 on to a conveyor 192 that feeds hopper 175A of the biomass stacker 175. In the embodiment shown in FIG. 9, biomass unloader unit 190 has a platform 193 on to which the truck tipper or similar bulk handling mobile cart 330 can be reversed over a ramp 191 for delivery of biomass to the hopper 175A.

Alternatively, the dried biomass could be unloaded from the truck tipper or similar bulk handling mobile cart 330 into a pile adjacent to a mobile biomass stacker 175 and loaded into the hopper of biomass stacker 175 with a front end loader equipped with a low tare weight, large capacity, biomass bucket 1120, as described above. The hopper forms the materials entry point for mobile biomass stacker 175, materials here including biomass and some soil.

In embodiments, the mobile biomass stacker 175 is located on the centre line of the long axis of the BSF storage pad 174. The capacity of biomass stacker 175 to move the biomass and soil (as described below) from the biomass (and soil) hopper to the top of the biomass stack 180 (for example 20 m in height), and to efficiently fill the BSF storage pad 174 with stacked biomass and soil covering, is matched to:
the height and width of biomass stack 180;
the size of the BSF storage pad 174; and
the capacity of the BRM 320 and biomass transport machine(s) 330.

The hopper of stacker 175 conveniently holds at least a single bucket load of biomass from biomass bucket 1120 allowing the biomass transport machine 330 to return for loading at the BDF 150 while the dumped load of biomass is loaded and stacked. Multiple biomass transport machines 330, conveniently truck based tippers or similar bulk handling mobile carts, may be deployed and in operation dependent on the capacity of the biomass carbon dioxide sequestration system 100.

Biomass stack 180 construction conveniently starts at one end 174a of the BSF storage pad 174. Biomass stack 180 grows longitudinally in a direction parallel to the long axis of the BSF storage pad 174 as the biomass stacker 175 incrementally moves, in direction shown by arrow ST, toward the other end 174b of the BSF storage pad 174 as indicated in FIG. 8.

Mobile biomass stacker 175 is able to move biomass from the hopper 175A by conveyor 176 onto the top of the biomass stack 180, biomass falling onto the biomass stack 180 in direction B. Fresh dried biomass is continuously added to the top of the biomass stack 180 growing the stack at its natural angle of repose, until the base of the biomass stack extends to a determined relatively short distance, for example 1 m, short of the short-axis edge of the BSF storage pad 174 which corresponds with end 174b of storage pad 174.

Biomass stack 180 can be constructed in various ways, the following being illustrative of just one method of construction. In one alternative embodiment, the biomass stack 180 is built as follows: after the payload of transported dried biomass has been weighed, the biomass transport machine(s) 330 dump the dried biomass load directly onto the BSF storage pad 174, with each subsequent load adjacent to the previous load forming a mostly continuous flat stack of biomass around 2 m thick.

A Front End Loader (FEL) or equivalent tractor, with an push up rake blade extending between 5 and 15 m beyond the front wheels of the FEL or tractor (similar to that used to push up silage or grain stacks), is positioned at right angles to the stack edge. The push up rake blade is lowered to ground level at edge of the biomass stack 180.

The FEL/tractor is driven forward with the rake blade rising at the same rate as forward motion of the FEL/tractor to move the outermost biomass towards the centre of the stack and create as steep as possible angled outside edge to the biomass stack 180. The rake blade is repositioned adjacent to the previous position of pushing up and the operation is repeated, until the entire stack edge has been pushed up. The pushing up of the biomass is continued until the stack footprint is as small as possible and the outside walls are as steep as possible. Advantageously, the outside walls of the stack form a continuous flat surface to the centre ridge of the biomass stack.

Once the biomass stack 180 reaches design height and basal width, the mobile stacker 175 is moved a short distance, for example about 1 m, in a direction parallel to the long axis 174L of the BSF storage pad 174 and in a reverse direction towards end 174a of BSF storage pad 174. The object is to ensure that the biomass stack 180 grows evenly and longitudinally in a direction parallel with the long axis 174L of BSF storage pad 174 until filled to capacity with stacked biomass.

Once the stacking of the dried biomass is complete, the biomass stack 180 is ready for the installation of a protective roof structure 182 to keep the stacked dried biomass dry and dark and to eliminate the impact of the rain ingress into the dried biomass within biomass stack 180 as well as the risk of fire from a lightning strike.

Once the entire BSF storage pad 174 is filled with stacked biomass, the mobile biomass stacker 175 is moved from the storage pad 174 to a location adjacent to the storage pad 174. The top of stacker 175 outload is directed towards the centre of the biomass stack 180 and at right angles to the edge of the BSF storage pad 174. The hopper of the biomass stacker 175 is filled with relatively dry, high clay content soil, but if an impermeable membrane 182 is used as a roof structure, then the soil cover layer can be any soil type but conveniently the same as that used to construct the BSF storage pad 174. The soil cover layer, typically being of incombustible material, also assists with fire proofing.

The soil is transferred to the hopper by a mobile transport machine, conveniently a truck-based tipper 330. The mobile biomass stacker 175 moves the soil from the hopper onto the top of biomass stack 180, continuously adding fresh soil to the top of the stack, growing the soil cover at the soil's natural angle of repose, until the base of the soil cover on top of the biomass stack 180 extends between the edges or ends 174a and 174b of the BSF storage pad 174. The soil cover is sufficiently thick and continuous to cover all of the material—in particular chunked and dried logs, twigs and branches etc.—of the biomass stack 180. The soil cover is built up to a desired thickness, conveniently between about 300 mm and about 1000 mm, for example 500 m. The soil cover thickness selected is preferably based on the soil properties in terms of hydraulic conductivity etc. That is, the selected thickness should be sufficient to prevent moisture permeation into the biomass stack 180.

Biomass stacker 175 moves laterally around the biomass stack 180, directing soil towards the centre of the biomass stack 180 incrementally from all sides until all of the stacked biomass is covered in soil and the biomass is not visible.

An alternative method of depositing soil cover layer 182 onto the stack is to use a FEL to dump the soil onto the biomass and a FEL/tractor/push up blade similar to that described above to push and spread the soil cover layer 182.

An alternative to using a soil cover layer 182 to cover the biomass prior to the installation of the impermeable plastic membrane is to deposit and spread chipped biomass onto the biomass stack. The chipped biomass is desirably comprised of 5 mm and 25 mm pieces and ideally around 15 mm pieces, and is conveniently sourced from the smaller pieces of the same dried biomass that is deposited onto the BSF storage pad 174. A conventional industrial scale wood chipper may be directed at right angles towards the stack 180 so that a stream of biomass chips hits the stack 180 more or less at right angles. The wood chipper is moved, as necessary, to ensure that the layer of biomass chips builds up evenly to cover protruding large pieces of biomass that could damage the impermeable plastic membrane.

In one embodiment, the soil cover layer 182, is covered with a plastic membrane 182. In this embodiment, once the biomass stack 180 is covered in soil, the biomass stack 180 can either be covered in a strong plastic (HDPE, PPE, PVC or similar) membrane cover to provide roof protection of the biomass stack 180 from rainfall. Alternatively, the biomass stack 180 could be covered in another layer of soil, compactable to form a low hydraulic conductivity soil horizon capable of providing protection of the biomass stack 180 from rainfall.

If the plastic cover 182 option is employed, sheets of the strong plastic membrane material may be joined together, for example by gluing, welding or sewing, to form a continuous membrane that completely covers the biomass stack 180 and soil cover layer 182. Care should be taken, when installing the cover, not to puncture the plastic membrane. Any such puncture that does occur during installation should be repaired during the process of installation to ensure complete roof protection for biomass stack 180.

Once the plastic cover is installed, more soil is stacked in a further soil layer on top of the plastic membrane 182—as described above—to ensure that the plastic membrane 182 is not exposed to sunlight which would cause deterioration of the plastic over time. The further soil layer is prepared to prevent erosion over time. The further soil layer can be compacted, as described below, or planted with suitable plants. One suitable class of plants includes hardy, relatively shallow rooted locally adapted plants such as saltbush or other locally adapted hardy grasses to mitigate soil erosion.

Another embodiment does not utilise a plastic membrane. In this embodiment, another layer of soil is added to the biomass stack 180 similar to the further soil layer described above. This further soil layer is again of selected thickness to cover and protect biomass held within biomass stack 180. For example, the soil layer may have about twice the average thickness of the earlier described layer, for example about 1 m in thickness, a thickness selected to avoid moisture permeation into the biomass stack 180. In selecting thickness, regard may be had to the hydraulic conductivity of the soil.

In either embodiment, once the BSF storage pad 174 is covered in stacked biomass and the stacked biomass is in turn covered in soil, the soil is compacted to as close to optimal compaction as possible via achieving an optimal soil moisture content as close to 14 wt % moisture as practical for the soils described above and application of mechanical forces to achieve optimal compaction.

In one embodiment, the lower section of the biomass stack 180 soil layer is accessible with a large, heavy vibrating plate compactor conveniently attached to a boom of an excavator earth moving machine, modified such that the bucket is replaced with the vibrating plate compactor. Vibrating plate compactor may rotate such that its face may be oriented at a right angle to the surface of the soil cover layer. The boom of the excavator may be extended to enable to a selected portion, for example half the height of the biomass stack 180 to the whole of biomass stack 180.

A suitable vibrating plate compactor may have a surface area of at least 0.25 m², preferably about 1 m². It may have weight no less than 100 kg, preferably about 300 kg.

The excavator boom conveniently includes a water spray system including a water storage tank, water pump and plurality of spray nozzles, conveniently arranged proximate to the compactor plate. Water is pumped by the pump from the water storage tank to the plurality of spray nozzles to allow the soil to be wetted just prior to its compaction. The water pump is desirably regulated to ensure that the water for wetting is just sufficient for optimal compaction, thus minimising surface water run off.

The plate compactor is moved incrementally up and down and across the face of the soil cover layer, compacting the soil cover layer to achieve a layer of optimal soil compaction with as low hydraulic conductivity as possible to about half the height of the biomass stack 180.

A selected portion of the biomass stack 180 soil cover layer may be compacted by a different compactor. In one embodiment, the uppermost section of the biomass stack 180 is compacted with a towed, articulated passive twin roller compactor also having a water spray system including a water storage tank, water pump and plurality of spray nozzles, conveniently arranged proximate the compactor rollers. The water spray system is regulated to allow soil wetting just prior to its compaction as well as water wetting sufficient to enable optimal compaction with surface water run off minimised. The articulation mechanism of the twin roller compactor has at least one hydraulic ram to allow the rollers to be steered. The hydraulic ram is connected to hydraulic oil feed lines, extending to the tractor described below or to an on-board power pack.

The towed roller compactor moves in a direction down and up the slope of the soil cover layer of the biomass stack 180 from the very top of the stack's soil cover layer 182 to the top of the area already compacted from below with the mobile plate compactor, as described above. The towed roller compactor may conveniently be attached to ropes or cables which extend over the top of the soil cover layer 182 of the biomass stack and down to ground level on the side of the biomass stack 180 opposite to that where the roller is operating. The tow ropes or cables are further conveniently attached to a tractor directed at a right angle to the long axis of the stack. The tractor moves backwards and forwards dragging the roller compactor up and down the face of the stack several times for purposes of compaction.

Once a section of the soil cover layer 182 of biomass stack 180 has been wetted and compacted to optimal compaction, the hydraulic rams of the roller articulation mechanism are activated by the operator to steer the roller to an adjacent uncompacted section of the soil cover as it moves up or down the soil cover layer 182. Once the roller has been steered to a new section of uncompacted soil, the hydraulic rams are again activated to bring the roller back to a direction of travel being at a right angle to the long axis of the biomass stack 180. The roller is then dragged up and down the soil cover layer 182 several times until optimal compaction is achieved and the roller is again steered to adjacent uncompacted soil as described above.

In this manner, the whole of soil cover layer 182 of the biomass stack 180 is optimally compacted as indicated in FIG. 7. The compacted soil cover layer 182 may then be further covered in another layer of soil which may be planted with hardly relatively shallow rooted locally adapted plants such as saltbush or other locally adapted hardy grasses to mitigate soil erosion.

At this point, the construction of the BSF storage pad 174 and dried biomass stack 180 and cover 182 is complete and is ready for the operation of ongoing, long term monitoring as required to verify the effectiveness of the carbon dioxide sequestration system 100 in long term sequestration of carbon dioxide.

Long term monitoring of the condition of the sequestered dried biomass and the identification of early warning signs of biomass degradation or decomposition, allowing for prompt and efficient remedial action is necessary and beneficial, directly contributing to an independent verification and validation that the biomass captured CO₂ is effectively sequestered in accordance with accepted carbon accounting principles.

The monitoring system desirably includes multi-element gas and moisture sensors capable of measuring the concentration of O₂, CO₂, CO (with desirable minimum detection limits of 0.5%) and CH₄ (with a minimum detection limit of 2 ppm) temperature and relative humidity. Such sensors are installed to sample air flowing from within the biomass stack 180 into the vertical ventilation shaft(s) 187. The 3D position (x-y-z coordinates or polar coordinates) within the biomass stack 180 of each gas and moisture sensor is recorded. Anomalous concentrations of any organic gases, temperature or humidity readings indicate that the dried biomass is not being preserved as anticipated or is at risk of degrading or decomposing. The most likely root cause of organic gas emanations will be moist biomass. Spatially registered gas analysis data as described above is used and cross-checked with temperature and humidity readings to target and find any breaches in the protective roof structure or other causes of biomass decomposition, and to implement remedial actions to address the root cause of biomass decomposition.

The vertical ventilation shaft(s) 187 advantageously serve(s) as personnel access shafts to allow for sampling of the dried biomass stack. In such embodiment, the ventilation shaft(s) are of sufficient diameter (see above) to allow a person to climb down inside the ventilation shaft(s) 187, via a ladder fixed to the inside wall of the ventilation shaft(s) 187. The ventilation shaft(s) 187 have a series of sampling doors cut into and fixed to the inside wall. The sampling doors are of sufficient size to allow a person to sample the biomass stack 180 either directly by hand or with a sampling machine. The sampling doors are conveniently at least 0.2 m², preferably about 0.6 m² in surface area and conveniently sized for ready sealing against the wall of the ventilation shaft 187 sufficiently to ensure biomass does not escape. The sampling doors do not require to be air-tight, in particular where the air is dry as in an arid region as the occasional opening of sampling doors will not cause any significant risk of decomposition and loss of sequestered carbon dioxide.

Where included, the sampling doors are spaced evenly down and around the ventilation shaft 187 to ensure representative sampling of the biomass stack 180 is possible. Desirably, the arrangement would provide at least 1 door per 5 m of ventilation shaft 187, and preferably about 1 door per 2 m of ventilation shaft 187.

Biomass that enters the system 100 should be weighed and representatively sampled and analysed for moisture content and Total Organic Carbon (TOC). Further, biomass that is dried and stored in the system 100 is representatively sampled and analysed over time for moisture content and TOC. All TOC analyses are on a bone dry basis by the Dumas process or similar. In embodiments, the total amount of carbon captured from the atmosphere in the fresh biomass is determined by multiplying the weight of the fresh biomass by its TOC content (on a bone dry basis). The total amount of carbon sequestered in the dried biomass may be determined by multiplying the weight of the fresh biomass by the TOC content (on a bone dry basis) of the dried biomass. The dried biomass is desirably multiply sampled: (i) spatially, in that each ventilation shaft is randomly and systematically sampled and (ii) temporally, in that there are a number of rounds of sampling over time.

Each load of dried biomass delivered to the BSF is conveniently weighed via on board load cells or a drive on weighbridge. The weight of the load is recorded and matched to a sample of the load. Each load of dried biomass delivered to the BSF is representatively sampled, in a fashion similar to that employed for the delivery of grain to a commercial storage facility. Each load is independently sampled, labelled and despatched for laboratory analysis. Load sampling density may vary, but should be sufficient to ensure an adequate sampling density for statistically significant measurement and analysis of the sample population.

Dried biomass is representatively sampled as it is deposited and stacked onto the BSF storage pad 174. This sampling may be continuous sampling of the flow of biomass being moved and stacked (as described above) and/or it could be sampling of the biomass stack 180 as it grows. The dried biomass sampling density may vary but should be sufficient to ensure an adequate sampling density and acceptable statistical significance for measurement and analysis of the sample population.

In preferred embodiments, dried and stacked biomass is representatively sampled once it is stacked via the sampling doors of the ventilation shaft(s) 187 as described above. The dried and stacked biomass spatial sampling density may vary but should be sufficient to ensure an adequate sampling density and acceptable statistical significance for measurement and analysis of the sampled biomass stack 180. The stacked biomass is also sampled via a series of sampling rounds over time after the stack is established. Early sampling rounds are relatively closely spaced, no more than 30 days apart and ideally around 14 days apart. Later sampling rounds are further spaced apart no more than 5 years apart and ideally around 12 months apart. The dried and stacked biomass temporal sampling density may vary but should be sufficient to ensure an adequate sampling density and acceptable statistical significance for measurement and analysis of the sampled biomass stack and ultimately determination of long term carbon preservation within the dried stacked biomass.

The simplicity of the biomass delivery, drying, moving and stacking system and the efficient access to the stack for on-going sampling allows for ready, independent sampling analysis and verification and validation of the atmospheric CO₂ effectively sequestered in the dried stacked biomass, in accordance with established carbon accounting principles.

Key advantages of the system for biomass carbon dioxide sequestration described herein are the effective delivery of simple, cost-effective, large-scale, readily-monitored and verified, direct from the atmosphere Carbon Dioxide Removal (CDR), carbon sequestration.

The system advantageously increases the affordability, availability, and measurability of CDR certificates, allowing for an increase in uptake of CDR, lower atmospheric CO₂ levels and a correspondingly decreased atmospheric warming. Further, the system for biomass carbon dioxide sequestration described herein utilises land unable to support agriculture or natural biodiversity and/or low-productivity farming land.

Those skilled in the art will appreciate that the system and method for biomass carbon dioxide sequestration described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

The invention described herein may include one or more range of values (e. g moisture composition, dimensions etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A system for biomass carbon dioxide sequestration comprising:
(a) a harvesting module for harvesting or collecting biomass;
(b) a drying module to which biomass assessed to have moisture content greater than a threshold moisture content by weight is directed from the harvesting module for drying said harvested biomass to a dry state where the dried harvested biomass has less than the threshold moisture content by weight; and
(c) a storage module for storing harvested biomass assessed to have moisture content by weight less than the threshold moisture content.

2. The system of claim 1, wherein harvested biomass from the harvesting module assessed to have less than the threshold moisture content by weight is directed to the storage module without further drying in the drying module.

3. The system of claim 1, wherein said threshold moisture content is an equilibrium moisture content below which microbial activity substantially reduces or stops altogether due to lack of availability of moisture necessary to sustain microbial activity.

4. The system of claim 3, wherein equilibrium moisture content is the moisture content in thermodynamic equilibrium with moisture in the surrounding atmosphere at a given relative humidity, temperature and pressure.

5. The system of claim 3, wherein the equilibrium moisture content is less than 30 wt % moisture, preferably 20 to 25 wt % moisture or below.

6. The system of claim 5, wherein the equilibrium moisture content is in the range 5 to 15 wt % moisture.

7. The system of claim 4, wherein said harvesting module comprises a chunker to control biomass particle size.

8. The system of claim 1, including a transport module which allows transport of biomass between harvesting and drying modules and between drying modules and storage modules.

9. The system of claim 8, wherein said transport module comprises at least one vehicle.

10. The system of claim 9, wherein said vehicle is configurable into a harvesting mode and a mobile storage mode.

11. The system of claim 4, wherein drying of biomass is by solar drying.

12. The system of claim 11, wherein the storage module is dry, dark, fire-proof, water proof and termite proof.

13. The system of claim 12, wherein the storage module is separated from ground by a termite barrier.

14. The system of claim 13, wherein the termite barrier comprises a saline layer, optionally comprising or consisting of sodium chloride.

15. The system of claim 4, further comprising a ventilation system for circulation of air through the stored biomass.

16. The system of claim 15, wherein said ventilation system comprises a system of perforated pipes extending through the stored biomass.

17. The system of claim 16, comprising at least one ventilation stack extending beyond the stored biomass.

18. The system of claim 17, wherein the ventilation stack is modular, allowing a length of the ventilation stack to be modified dependent on quantity of stored biomass.

19. The system of claim 17, wherein the ventilation stack comprises an extractor fan for creating a draft through the stored biomass.

20. The system of claim 4, wherein the storage module further comprises a monitoring system for monitoring a parameter which may be selected from the group consisting of biomass moisture content, biomass temperature, relative humidity of ventilation air and gas composition of ventilation air.

21. The system of claim 20, wherein gas composition monitoring includes monitoring of CO₂, CO and/or CH₄ composition by selected sensor(s).

22. The system of claim 20, wherein the storage module has a structure preventing migration of moisture into the stored biomass, said structure comprising a base layer preventing upward migration of moisture into said stored biomass and a roof structure preventing downward and/or lateral migration of moisture into the stored biomass.

23. The system of claim 22, wherein said storage module is surrounded by a floodwater barrier.

24. A method for biomass carbon dioxide sequestration comprising:
(a) harvesting or collecting biomass;
(b) drying said harvested biomass where harvested biomass is assessed to have moisture content greater than a threshold moisture content by weight so that the dried harvested biomass has less than the threshold moisture content by weight;
(c) storing said dried harvested biomass assessed to have less than the threshold moisture content by weight; and
(d) ventilating said stored harvested biomass by ventilation air.

25. (canceled)

26. The method of claim 24, comprising monitoring of the gas composition of said ventilation air wherein monitored gas composition indicating deterioration of said dried harvested biomass enables a defect in the storage module to be identified.

27. (canceled)
